(19) United States
(12) Patent Application Publication
(10) Pub. No.: US 2012/0060344 A1
(43) Pub. Date: Mar. 15, 2012

(54) Side Mirror Protective Cover

(76) Inventor: Ryan T. Smeets, Washington, DC (US)

(21) Appl. No.: 13/216,452

(22) Filed: Aug. 24, 2011

Related U.S. Application Data
(60) Provisional application No. 61/381,195, filed on Sep. 9, 2010.

(51) Int. Cl. B60J 11/06; B23P 11/00; B65D 65/22

(52) U.S. Cl. 29/428; 150/166

(57) ABSTRACT

A protective cover for automobile side view mirrors is disclosed and claimed. The cover protects the non-mirrored side from damage while providing an unobstructed view of the mirror to the vehicle operator. The cover is self-tightening, and an optional sinching element and retaining element may be included. A graphic may be provided on the back side of the cover, opposite the mirrored surface.

### CROSS-REFERENCE TO RELATED APPLICATIONS

This patent application claims the benefit of U.S. Provisional Patent Application No. 61/381,195 filed on Sep. 9, 2010, which is incorporated herein by reference in its entirety,

### BACKGROUND OF THE INVENTION

1. Field of the Invention

The present invention relates to a protective cover, and, more particularly, the present invention relates to a protective cover for the side view mirrors of vehicles.

2. Description of the Related Art

During every day driving, a great deal of foreign matter such as road grime, tar, rocks, and insects are thrown up against the frontal surfaces of automobiles. This foreign matter often strikes the frontal areas of the vehicle at great speed and with great force and causes damage to the vehicle body and finish. The vehicle side view mirrors are particularly vulnerable to this type of damage.

Known protective side view mirror covers are made out of plastics or metals, and must be held together by screws or adhesives. What is needed is an adaptive, easy to install side view mirror protector.

### SUMMARY OF THE INVENTION

The instant invention is an automobile side view mirror protective cover that is made of a cloth such as a spandex/polyester blend that adheres to the existing shape of the mirror. The protective cover itself attaches to the side view mirror as a result of the material adapting to reshape itself to the side view mirror. The protective cover may also be tightened by the user to ensure a tight, aerodynamic fit. The cover protects the non-mirrored side from damage while providing an unobstructed view of the mirror to the vehicle operator.

The instant invention solves the problem of ensuring that the cover remains fixated and attached to the side view mirror of an automobile both at rest and at high speeds. This is ensured because of the fabric comprising the invention. As a result of the fabric design, customization can easily be made to allow for promotional branding purposes, team or school spirit, national pride, or other emblems.

### DESCRIPTION OF THE DRAWINGS The present invention is described with reference to the accompanying drawings, in which like reference characters reference like elements, and wherein:

FIG. 1 shows a mirror-side view of a protective cover of the present invention in place on a first automobile side view mirror;

FIG. 2 shows a back view of the protective cover of FIG. 1;

FIG. 3 shows a mirror-side view of a protective cover of the present invention in place on a second automobile side view mirror;

FIG. 4 shows a back view of the protective cover of FIG. 3;

FIG. 5 shows a blank used to form a protective cover of the present invention;

FIG. 6 shows a prospective view of the protective cover formed from the blank of FIG. 5; and

FIG. 7 shows a protective cover of the present invention,

### DETAILED DESCRIPTION OF THE INVENTION

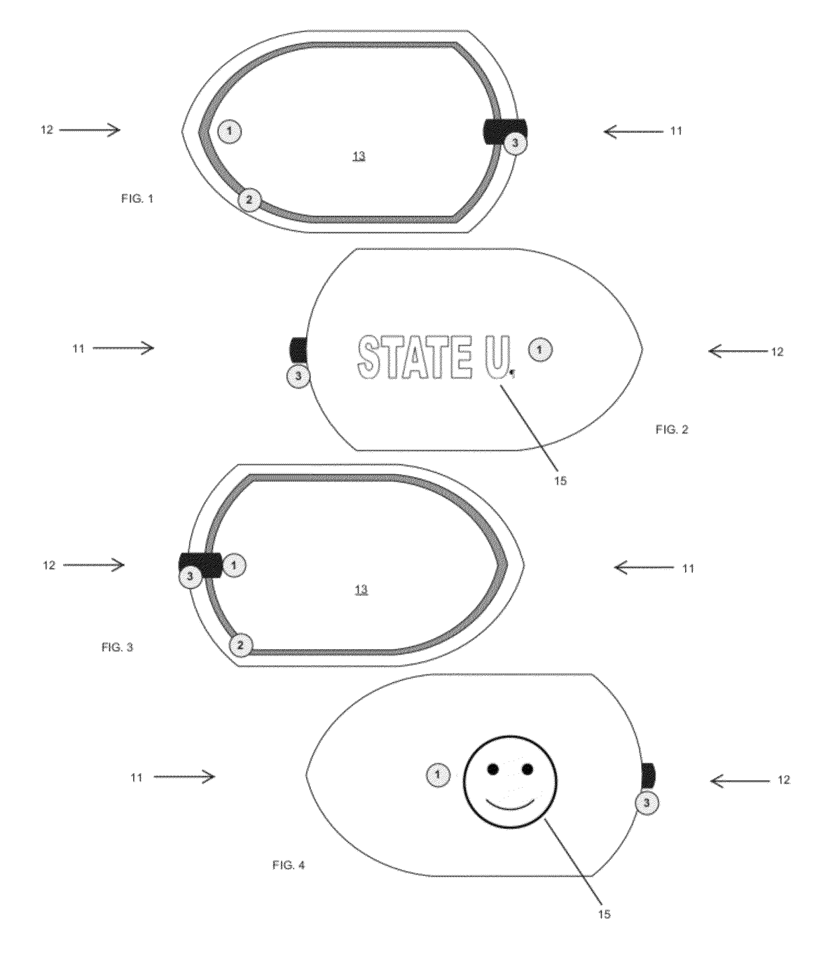

The present invention relates to a protective cover for the side view mirrors of automobiles. FIG. 1 shows a mirror-side view of a protective cover 1 of the present invention in place on a first automobile side view mirror. The cover 1 contains an open end 11 by which the cover 1 is positioned around the side mirror to be protected. The opposing end 12 of the cover 1 is closed. Preferably, the closed end 12 is contoured to facilitate a tight, aerodynamic fit around the side mirror. To further facilitate a tight fit, the cover 1 preferably is formed of an elastomeric material, such as polyester and/or spandex, which allows the cover 1 to adapt to fit mirrors having a variety of sizes and shapes. FIG. 2 shows a back view of the cover 1 of FIG. 1, and illustrates the preferred tight fit. The cover 1 protects the non-mirrored side from damage while providing an unobstructed view of the mirror to the vehicle operator.

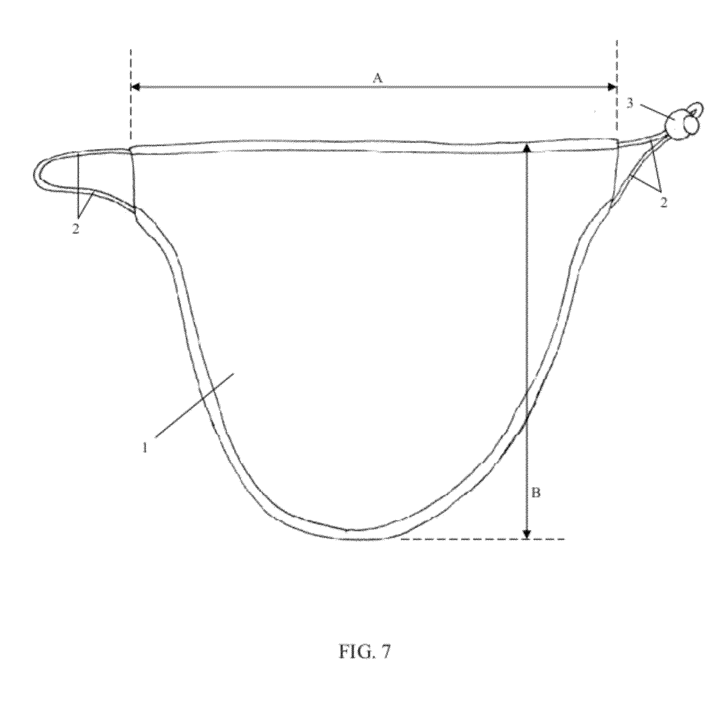

FIGS. 3 and 4 shows views similar to those of FIGS. 1 and 2, respectively, but on the opposite side of the vehicle. Preferably, the covers 1 are not side-specific; that is, a single cover 1 may be used on the mirrors of either side of the vehicle. The elastomeric material of the covers 1 allows them to adapt to the altering shapes of the mirrors of either vehicle side. Moreover, the covers 1 can be used on one mirror of a vehicle, removed, and used on the other side mirror of the vehicle. If the vehicle mirrors are large and unsymmetrical, however, the shape of the covers 1 may be customized to ensure a tight, aerodynamic fit, in which case the covers 1 may be side-specific. A variety of sizes may be provided to accommodate mirrors of vehicle of varying size, such as one size for standard vehicles such as sedans, and a larger size for sport utility vehicles and trucks, and a still larger size for large trucks. A preferred size for the cover 1 for use with sedans and similar vehicles is approximately 23-29 cm by 20-26 cm; a preferred size for the cover 1 for use with SUVs and trucks approximately 27-33 cm by 22-28 cm; a preferred size for the cover 1 for use with large trucks and similar vehicles is approximately 36-42 cm by 30-36 cm. However, other sizes can also be used. FIG. 7 shows an example protective cover 1 with dimensional references illustrating how the above dimensions (A by B) were measured.

The cover 1 defines an opening 13 through which the vehicle occupants can view and use the mirror. A sinching element 2 surrounds the opening 13 and serves as a stop against which the elastomeric material of the cover 1 exerts a pulling force. The sinching element 2 may be encapsulated within the cover 1 about the opening 13, such as being sewn into a peripheral seam of the cover 1. The user positions the sinching element 2 about the periphery of the mirror, and equilibrium retains the cover 1 in place.

Preferably, the sinching element 2 is formed of an elastomeric material, such as nylon, and is thus self-tightening. The elastomeric properties of the sinching element 2 and the material of the cover 1 cooperate to keep the cover 1 in position about the mirror, even when the vehicle is moving at high speeds. Additionally or alternatively, a retaining element 3 can be included to allow the user to vary the length of the sinching element 2. By varying the length of the sinching element 2, the user can selectively vary the size of the opening 13 and the tightness of the fit of the cover 1 about the mirror. An opening may be provided in the seam encapsulating the sinching element, through which a portion of the sinching element 2 is exposed. Preferably, the opening is reinforced to prevent it from tearing and positioned to be at an inner portion of the mirror when in position. The retaining element 3 can be positioned about the sinching element 2 extending through the opening. The retaining element 3 may contain a spring-biased member that selectively prevents or allows movement of the sinching element 2 therethrough, For example, the retaining element 3 may include two parts having through-holes that cooperate to form a passage through the retaining element 3. The parts are relatively movable, such that the through-holes can be moved out of alignment. A spring is provided to bias the parts out of alignment. When the sinching element 2 has been placed within the through-holes of both parts, the spring biases the parts out of alignment, causing the capture and retention of the sinching element 2 between the parts of the retaining element 3. Such a retaining element 3 may be formed of a durable material, such as a plastic. Additional designs for the retaining element 3 may also be used.

To form the cover 1, a blank is cut from a bolt of material, such as polyester and/or spandex. The blank preferably is sized to accommodate a variety of mirror sizes. A tapered ellipse is a preferred shape for the blank. Once the blank is formed, the sinching element 2 can be sewn into the fabric by folding the fabric around the sinching element 2 and stitching the fold together. An opening may be provided in the seam, though which a portion of the sinching element 2 is extended. A retaining element 3 may be coupled to the exposed portion of the sinching element 2. Preferably, the seam opening is reinforced such as by providing reinforced sewing such as is used with a button hole.

In use, the user slips the cover 1 over the mirror to be protected. This may be accomplished by grasping the open end 11 of the cover 1 and pulling it inward, toward the vehicle. The user may also roll the open end 11 toward the closed end 12, slip the cover 1 over is the tip of the mirror to be protected, and unroll the cover 1 inward toward the vehicle. Once the cover 1 has been slipped over the mirror, the user ensures the opening 13 is centered on the mirror and the mirror is visible by the vehicle operator. The sinching element can be tightened using the retaining element 3. This process is repeated for each mirror to be protected. For safety reasons, the cover 1 should be installed while the vehicle is stopped. The mirror is thus protected from dust or other elements that could be harmful to the paint of the side view mirror. It can also be used as a way of promoting or advertising a specific message that could be graphically printed on to the fabric of the cover 1 itself. Graphics can be applied in a variety of ways. Two preferred methods include screen printing, wherein the graphic is applied using woven mesh and a ink blocking stencil, and dye-sublimation, wherein the graphics are dyed and embedded into the cover 1 material. Sublimation is more preferred because it prevents cracking, fading, or peeling of the graphic. Example graphics 15 are illustrated in FIGS. 2 and 4. The graphics 15 may comprise a trademark, service mark, logo, copyright, emblem, text, or the like.

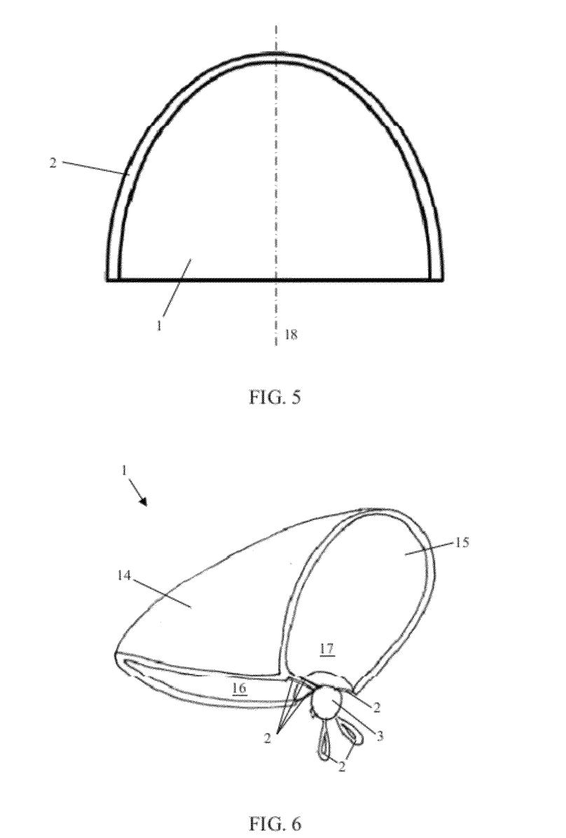

FIG. 5 shows a blank used to form a protective cover 1. As shown in the illustrative example, the protective cover 1 has a semicircular shape when laid flat. The sinching element 2 is provided at the perimeter of the cover 1. FIG. 6 shows a prospective view of the protective cover 1 formed from the blank of FIG. 5. The blank has been folded, generally about its axis of symmetry 18 to form an outside surface 14 that is exposed to the environment and an inside surface 15 that is placed adjacent the mirror to be protected. Folding the blank forms two holes or voids in the perimeter of the cover body; a first void 16 accommodates the perimeter of the mirror to be protected, and a second void 17 accommodates the stem or arm of the mirror by which it is attached to the vehicle. In other words, the first void 16 accommodates a main perimeter of the mirror to be protected and the second void accommodates a secondary perimeter of the mirror to be protected. Ends of the sinching element 2 extend out of the cover 1 to the retaining element 3. As shown in the illustrative example of FIG. 6, two sinching elements 2 may be used with the protective cover 1. Looping or connecting the ends of each sinching element 2 ensures the integrity of the cover 1 and prevents the sinching elements 2 from being captured within the hem of the cover 1. The sinching elements 2 each contain a first portion that is embedded within a hem of the cover 1 and a second portion that is exposed. The sinching elements 2 are coupled to the retaining element 3 on their exposed portions. Preferably, each sinching element is retained via a single retaining element 3.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

What is claimed is:

1. A cover, comprising:
a body having a shape to accommodate an object to be protected, said body having a first surface and a second surface, said first surface being adjacent the object when in use;
a sinching element provided in a perimeter of said body; and
a retaining element coupled to said sinching element.

2. The cover of claim 1, wherein said sinching element is retained within a hem of said body.

3. The cover of claim 1, wherein said sinching element is a loop, a first portion of said sinching element being embedded within a hem of said body and a second portion of said sinching element being exposed, said sinching element being coupled to said retaining element on said exposed portion.

4. The cover of claim 1, wherein said body is formed of an elastomeric material.

5. The cover of claim 1, wherein said sinching element is formed of an elastomeric material.

6. The cover of claim 1, wherein said retaining element is spring-biased to selectively retain its position on said sinching element.

7. The cover of claim 1, further comprising a second sinching element, said sinching elements provided in hems of said body, said sinching elements cooperating to form voids in said perimeter.

8. The cover of claim 7, wherein a first of said voids is adapted to accommodate a perimeter of the object to be protected and a second of said voids is adapted to accommodate an attachment arm of the object to be protected.

9. The cover of claim 7, wherein each of said of said sinching element is a loop having a first portion being embedded within a hem of said body and a second portion being exposed, said sinching element being coupled to said retaining elements on said exposed portions.

10. The cover of claim 9, wherein said sinching elements are separate and independent, each of said sinching elements being retained within separate and independent hems of said body.

11. The cover of claim 1, wherein said second surface contains an informative indicium.

12. The cover of claim 11, wherein said indicium comprises a trademark, service mark, logo, emblem, text, or the like.

13. A method of protecting an object, comprising:
providing a cover including a body having a shape to accommodate the object to be protected, said body having a first surface and a second surface, said first surface being adjacent the object when in use, a sinching element provided in a perimeter of said body, and a retaining element coupled to said sinching element;
forming said cover to form a void adapted to accommodate a perimeter of the object to be protected;
placing said cover about the object to be protected such that a main perimeter of the object is positioned within said void;
adjusting said sinching element to a use position that forms an aerodynamic fit of said cover on the object; and
securing said sinching element with said retaining element to retain said sinching element in said use position.

14. The method of claim 13, further comprising forming said cover to form a second void adapted to accommodate an attachment arm or the object to be protected, and wherein:
said placing includes placing said cover about the object to be protected such that a secondary perimeter of the object is positioned within said second void; and
said adjusting includes forming an aerodynamic fit of said cover about the main and secondary perimeters of the object to be protected.
